(19) United States
(12) Patent Application Publication
(10) Pub. No.: US 2013/0309507 A1
(43) Pub. Date: Nov. 21, 2013

(54) Wood Effect Fireplace Cabinet Trim

(71) Applicant: KWONG YING LAU, Dong Guang (CN)

(72) Inventor: KWONG YING LAU, Dong Guang (CN)

(21) Appl. No.: 13/473,555

(22) Filed: May 16, 2012

(51) Int. Cl. B32B 21/04

(52) U.S. Cl. CPC B32B 21/042
USPC 428/425.1

(57) ABSTRACT

A wood effect fireplace cabinet trim for fixing onto the surface of the fireplace cabinet, comprising a trim body made of wood-based panels. a trim body, a wood grain paper layer, and a PU protective layer. Wood grain paper layer is paste onto the panel surface of the trim body to produce real wood effect. Various style of wood grain paper can be used to achieve different wood effect.

### BACKGROUND OF THE INVENTION

1. Field of the Invention

The present invention relates to a fireplace cabinet, in particular, is involved in a decorative wood trim to be attached to the surface of a fireplace cabinet.

2. Description of the Related Art

Fireplace cabinet in cold weather regions, especially Europe and the United States is widely used. Various decorative trims are available for attaching to the surface of a fireplace cabinet to achieve more elegant look. Currently there are two main types of fireplace cabinet trim available in the market: the first type is a fireplace cabinet trim made of solid wood; and the second type is a fireplace cabinet trim made of processed wood with spray painted wood effect. In both of these types of fireplace cabinet trim there is a concern of consuming large quantities of woods, environmental pollution and high product cost.

Therefore it is desirable to provide a fireplace cabinet trim with a low production cost and is environmental friendly, as well as providing aesthetic look of desirable wood effect.

### SUMMARY OF INVENTION

The objective of this invention is to overcome the inadequacies of existing technologies by providing a wood effect fireplace cabinet accessories; it has low production costs, good decorative effect, as well as saving energy and natural resources.

To achieve the above objectives, the present invention provides a wood effect fireplace cabinet trim, fixed at the surface of the fireplace cabinet. The trim comprises a trim body made from wood-based (process wood) panels, a wood grain layer, and a PU protection layer.

As an optimization of the trim body, the trim body can be in the form of strip of plate.

As an optimization of the wood grain layer, the wood grain layer can be attached to the trim body with adhesive material or press attached to the trim body.

As an optimization of the trim body, the trim body can be attached to the surface of fireplace cabinet with adhesive material or simply couple to the surface of fireplace cabinet.

The beneficial effects of the present invention are: using the process wood with wood grain layer to produce real wood effect of fireplace cabinet not only achieves low production cost, but also provide aesthetics looks, and at same saving trees and reducing environmental pollution.

### DESCRIPTION OF THE DRAWINGS

FIG. 1 is an illustration of the trim body in strip form;

FIG. 2 is an illustration of the cross section of the trim body in FIG. 1;

FIG. 3 is an illustration of the trim body in plate form;

FIG. 4 is a frontal view of fireplace cabinet with the trim; and

FIG. 5 is a side view of fireplace cabinet with the trim.

### DETAILED DESCRIPTION OF THE PREFERRED EMBODIMENT

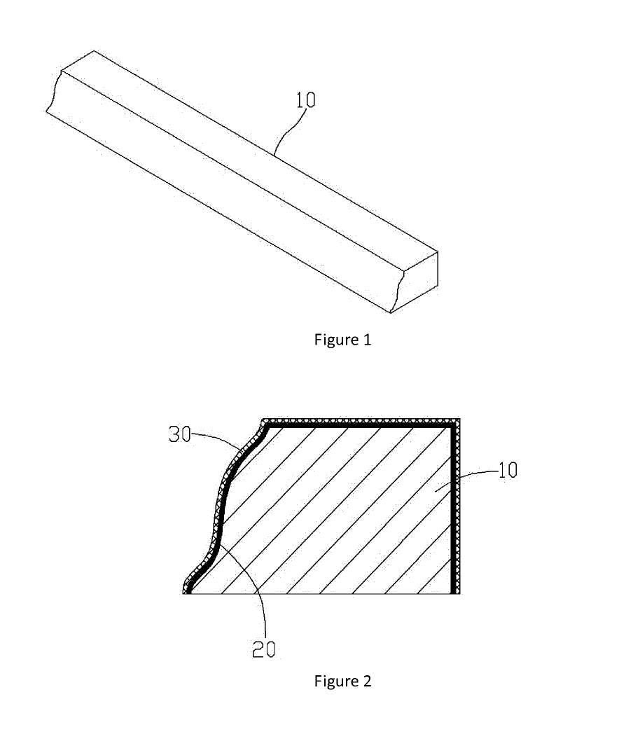

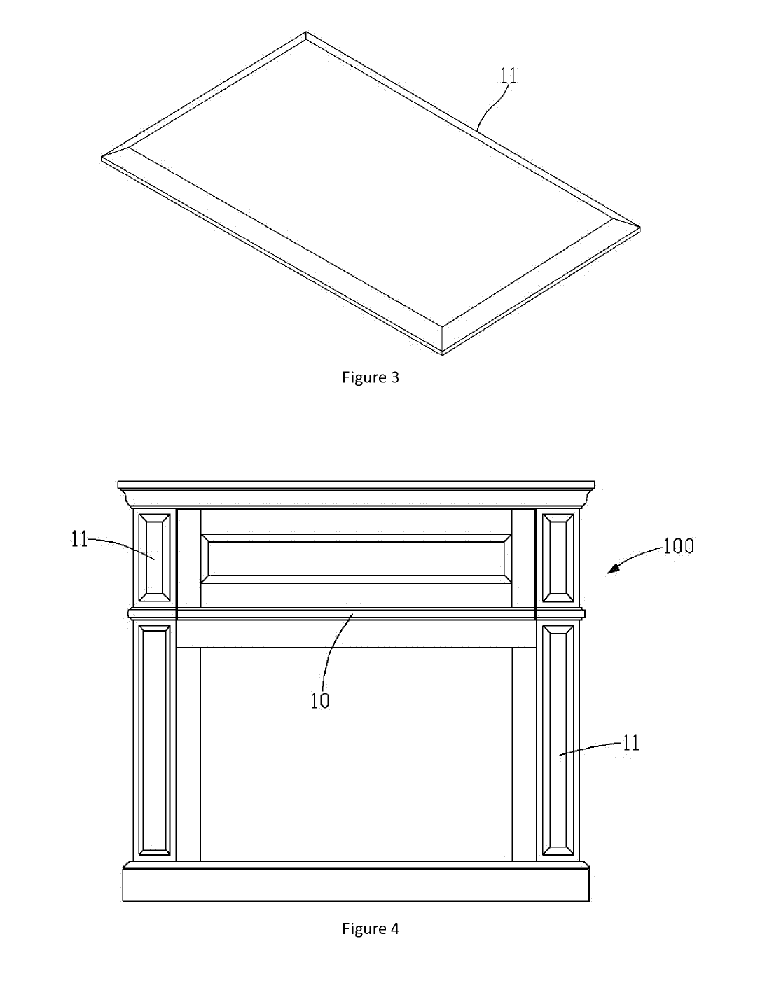

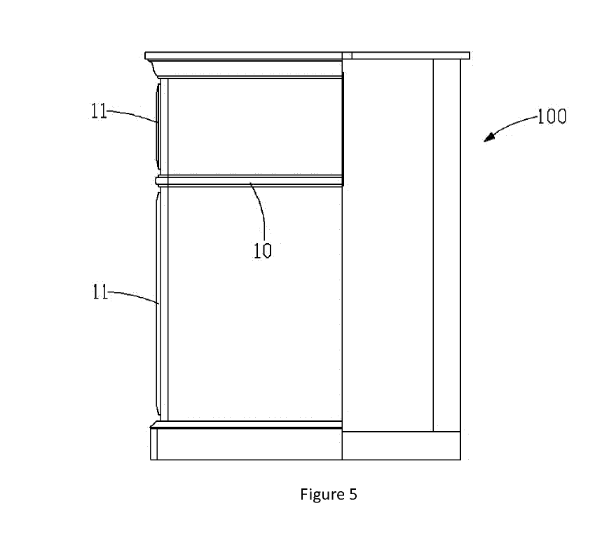

As illustrated in FIG. 1 through FIG. 5: the wood effect fireplace cabinet trim of the present invention has two types, first one is a strip trim 10, and the second one is a plate trim 11. Both of the strip trim 10 and plate trim 11 can be using adhesive or mounted fixed on the surface 100 of fireplace cabinet.

As illustrated in FIG. 2: strip trim 10 is made of processed wood (same applies to plate trim 11), a wood grain layer 20 is adhered to the surface of strip trim 10. In another embodiment, the wood grain layer 20 is fed through a machine and attached to the surface of strip trim 10. A second layer of PU layer 30 is then apply to the wood grain layer 20 for protection of the wood grain layer 20. The PU layer also provide scratch resistance to the wood grain layer.

It should be understood that the above embodiment is only used to describe the technical solution of the present invention rather than limit the scope of protection of the present invention, the person of ordinary skill in this field should expect that any modification or equivalent replacement will fall in the scope of the invention.

What the invention claimed is:

1. A wood effect fireplace cabinet trim for fixing at the surface of a fireplace cabinet comprising: a trim body made by wood-based panels, a wood grain layer overlaying said trim body and a protective PU layer overlaying said wood grain layer; characterized in that: said trim body can be directly adhered or mounted onto the surface of a fireplace cabinet.

2. The wood effect fireplace cabinet trim as claimed in claim 1 wherein, it is characterized in that said trim body is in strip shape.

3. The wood effect fireplace cabinet trim as claimed in claim 1 wherein, it is characterized in that said trim body is in plate shape.

4. The wood effect fireplace cabinet trim as claimed in claim 1 wherein, it is characterized in that said wood grain layer is adhere to the said trim body surface.

5. The wood effect fireplace cabinet trim as claimed in claim 1 wherein, it is characterized in that said wood grain layer is press attached to the said trim body surface.

6. The wood effect fireplace cabinet trim as claimed in claim 1 wherein, it is characterized in that said trim body can be fixed onto the surface of a fireplace cabinet with adhesive material.
